(19) United States
(12) Patent Application Publication
(10) Pub. No.: US 2024/0198225 A1
(43) Pub. Date: Jun. 20, 2024

(54) INFORMATION PROCESSING APPARATUS AND COMMENT GENERATION METHOD

(71) Applicant: Sony Interactive Entertainment Inc., Tokyo (JP)

(72) Inventors: Shinichi HONDA, Tokyo (JP); Ryo NAKAHASHI, Tokyo (JP); Tetsuya HIGASHINO, Tokyo (JP); Shinji TAKASHIMA, Tokyo (JP); Hiroyuki SEGAWA, Tokyo (JP)

(73) Assignee: Sony Interactive Entertainment Inc., Tokyo (JP)

(21) Appl. No.: 18/555,061

(22) PCT Filed: Apr. 23, 2021
(86) PCT No.: PCT/JP2021/016419

§ 371 Date: Oct. 12, 2023

(51) Int. Cl. A63F 13/53; A63F 13/812

(52) U.S. Cl. CPC A63F 13/53; A63F 13/812

(57) ABSTRACT

A state data acquisition unit 120 acquires state data indicative of a progress state of a game. A situation estimation unit 122 estimates a user's game situation from the acquired state data. An internal state estimation unit 124 estimates an internal state of the user from the estimated game situation. A comment generation unit 126 generates a comment to the user on the basis of the estimated internal state of the user.

### TECHNICAL FIELD

The present disclosure relates to a technology for generating a comment to a user.

### BACKGROUND ART

PTL 1 discloses an object controlling system for controlling a robot. The object controlling system estimates an emotion of a user, manages an internal state of a robot and an internal state of the user on the basis of the estimated emotion of the user, determines utterance contents of the robot on the basis of the internal state of the robot, and causes the robot to speak.

### CITATION LIST

### Patent Literature

### [PTL 1]

Japanese Patent Laid-Open No. 2018-187712

### SUMMARY

### Technical Problems

In the object controlling system disclosed in PTL 1, in order to make it possible for a user to have a joint viewing experience with the robot, it is important for the robot to utter a comment appropriate for the occasion. Further, in recent years, together with growing popularity of game commentary or esports, the demand for a technology for automatically generating a comment without manual operation by the user is increasing.

The present disclosure has been made in view of such a subject as described above, and an object of the present disclosure resides in provision of a technology for generating an appropriate comment to a user.

### Solution to Problems

In order to solve the problems described above, an information processing system according to one aspect of the present disclosure is an information processing apparatus that generates a comment to a user who is playing a game, including a state data acquisition unit that acquires state data indicative of a progress state of the game, a situation estimation unit that estimates a user's game situation from the acquired state data, an internal state estimation unit that estimates an internal state of the user from the estimated game situation, and a comment generation unit that generates a comment to the user on the basis of the estimated internal state of the user.

Another aspect of the present disclosure is a comment generation method. This method includes a step of acquiring state data indicative of a progress state of a game, a step of estimating a user's game situation from the acquired state data, a step of estimating an internal state of the user from the estimated game situation, and a step of generating a comment to the user on the basis of the estimated internal state of the user.

It is to be noted that any combinations of the components described above and representations of the present invention where they are converted between a method, an apparatus, a system, a computer program, a recording medium on which the computer program is recorded readably, a data structure, and so forth are also effective as modes of the present disclosure.

### BRIEF DESCRIPTION OF DRAWINGS

FIG. 1 is a diagrammatic view depicting an information processing system 1 according to an embodiment.

FIG. 2 is a block diagram depicting a hardware configuration of an information processing apparatus.

FIG. 3 is a block diagram depicting functional blocks of the information processing apparatus.

FIG. 4 is a view depicting an example of a game screen.

FIG. 5 is a view depicting an example of a two-dimensional emotional model.

FIG. 6 is a view depicting an example of a comment.

### DESCRIPTION OF EMBODIMENT

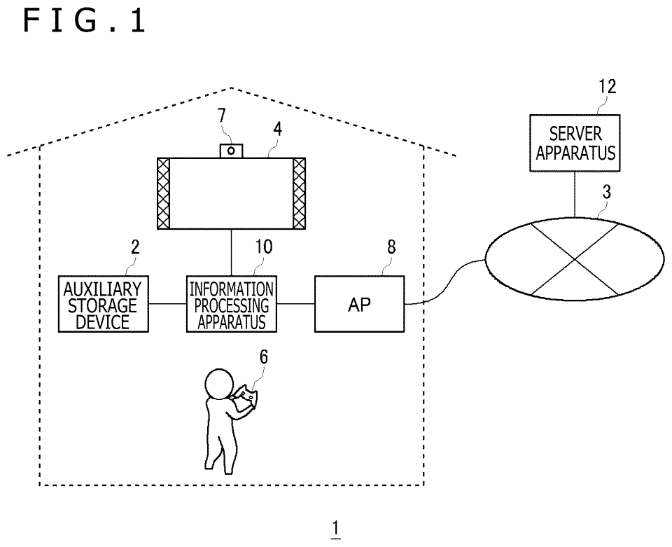

FIG. 1 depicts an information processing system 1 according to an embodiment of the present disclosure. The information processing system 1 includes an information processing apparatus 10 and a server apparatus 12. An access point (AP) 8 has functions of a wireless access point and a router, and the information processing apparatus 10 connects to a network 3 such as the Internet or a local area network (LAN) through the AP 8 to establish connection for communication with the server apparatus 12.

The information processing apparatus 10 establishes connection with an inputting device 6, which is operated by a user, by wireless or wired connection, and the inputting device 6 transmits operation information of the user to the information processing apparatus 10. The information processing apparatus 10 reflects the operation information of the user on processing of an operating system or a game and outputs a result of the processing from an outputting device 4. The information processing apparatus 10 of the embodiment may be a terminal apparatus such as a game machine or a personal computer for executing a game, and the inputting device 6 may be equipment such as a game controller that supplies the operation information of the user to the information processing apparatus 10.

The inputting device 6 includes a plurality of inputting units such as a plurality of push-type operation buttons, an analog stick capable of inputting an analog amount, a rotatable button, and so forth. A camera 7 serving as an image capturing device is provided in the proximity of the outputting device 4 and captures an image of a space around the outputting device 4. While FIG. 1 depicts an example in which the camera 7 is attached to an upper portion of the outputting device 4, the camera 7 may be disposed alongside the outputting device 4. In any way, the camera 7 is disposed at a position at which the camera 7 can capture an image of a user who is playing a game in front of the outputting device 4. The camera 7 may be a stereo camera.

An auxiliary storage device 2 is a mass storage device such as a hard disc drive (HDD) or a solid state drive (SSD), and may be a built-in type storage device or an external storage device that is connected to the information processing apparatus 10 by a universal serial bus (USB) or the like. The outputting device 4 may be a television set that includes a display that outputs an image and a speaker that outputs sound, or may be a head-mounted display. The outputting device 4 may be connected to the information processing apparatus 10 by a wire cable or by wireless connection.

The server apparatus 12 provides a network service to a user of the information processing system 1. The server apparatus 12 manages a network account for identifying a user, and the user uses the network account to sign in to the network service provided by the server apparatus 12. By signing in to the network service from the information processing apparatus 10, the user can register into the server apparatus 12 save data of a game or a trophy that is a virtual reward acquired during game play. In the information processing system 1 of the embodiment, the server apparatus 12 provides two types of trained models relating to a game played by the user. The trained models are hereinafter described.

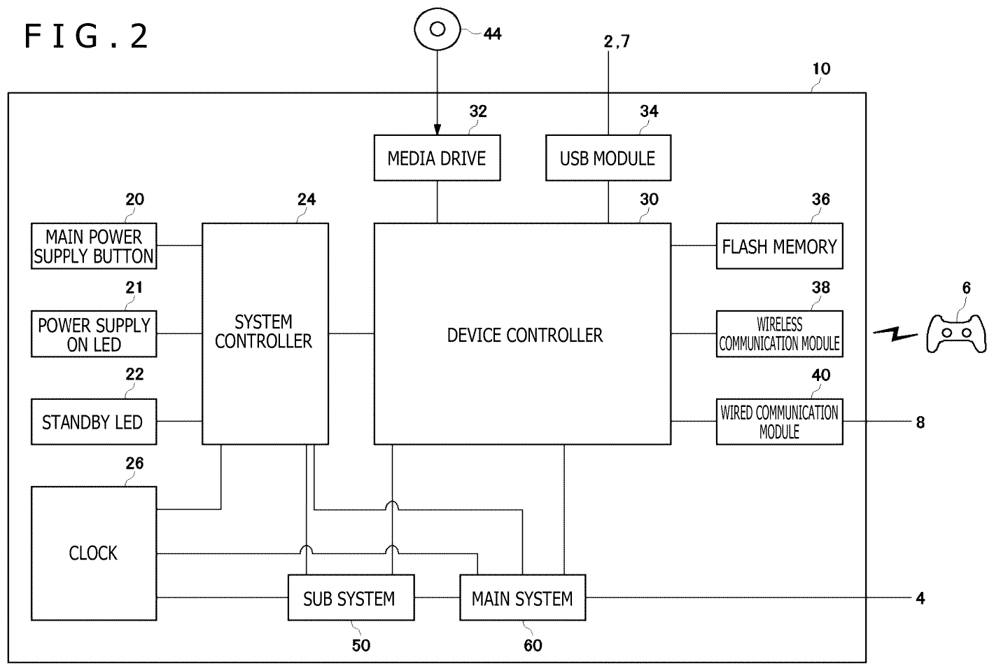

FIG. 2 depicts a hardware configuration of the information processing apparatus 10. The information processing apparatus 10 includes a main power supply button 20, a power supply ON light emitting diode (LED) 21, a standby LED 22, a system controller 24, a clock 26, a device controller 30, a media drive 32, a USB module 34, a flash memory 36, a wireless communication module 38, a wired communication module 40, a sub system 50, and a main system 60.

The main system 60 includes a main central processing unit (CPU), a memory that is a main storage device and a memory controller, a graphics processing unit (GPU), and so forth. The GPU is used mainly for a computation process of a game program. The main CPU has a function for starting system software and, in an environment provided by the system software, executing the game program installed in the auxiliary storage device 2. The sub system 50 includes a sub CPU, a memory that is a main storage device, a memory controller, and so forth but does not include a GPU.

While the main CPU has a function for executing a game program installed in the auxiliary storage device 2, the sub CPU does not have such a function as just described. However, the sub CPU has a function for accessing the auxiliary storage device 2 and a function for transmitting and receiving data to and from a management server 5. The sub CPU has only such limited processing functions and accordingly can operate with small power consumption in comparison with the main CPU. The functions of the sub CPU are executed when the main CPU is in a standby state.

The main power supply button 20 is an inputting unit for which operation inputting is performed by the user, and is provided on a front face of a housing of the information processing apparatus 10 and is operated in order to turn on or off the power supply to the main system 60 of the information processing apparatus 10. When the main power supply button 20 is turned on, the power supply ON LED 21 is turned on, and when the main power supply button 20 is turned off, the standby LED 22 is turned on. The system controller 24 detects depression of the main power supply button 20 by the user.

The clock 26 is a real time clock, and generates date and time information at present and supplies it to the system controller 24, the sub system 50, and the main system 60.

The device controller 30 is configured as a large-scale integrated circuit (LSI) that executes transfer of information between devices like a south bridge. As depicted in FIG. 2, to the device controller 30, such devices as the system controller 24, the media drive 32, the USB module 34, the flash memory 36, the wireless communication module 38, the wired communication module 40, the sub system 50, and the main system 60 are connected. The device controller 30 absorbs differences in electric characteristic and differences in data transfer rate of the devices to control the timing of data transfer.

The media drive 32 is a drive device that accepts and drives a read only memory (ROM) medium 44 in which application software of a game or the like and license information are recorded, to read out a program, data, and so forth from the ROM medium 44. The ROM medium 44 is a read only recording medium such as an optical disk, a magneto-optical disk, or a Blu-ray disk.

The USB module 34 is a module that establishes connection to external equipment by a USB cable. The USB module 34 may be connected to the auxiliary storage device 2 and the camera 7 by a USB cable. The flash memory 36 is an auxiliary storage device that configures an internal storage. The wireless communication module 38 communicates, for example, with the inputting device 6 by wireless connection using a communication protocol such as the Bluetooth (registered trademark) protocol or the IEEE 802.11 protocol. The wired communication module 40 communicates with external equipment by wired connection and connects to the network 3, for example, through the AP 8.

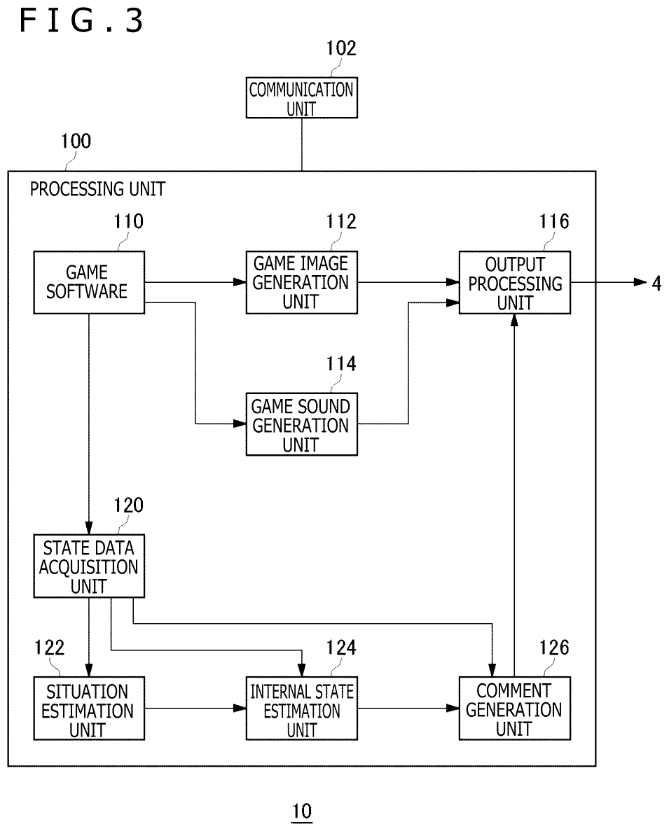

FIG. 3 depicts functional blocks of the information processing apparatus 10. The information processing apparatus 10 includes a processing unit 100 and a communication unit 102. The processing unit 100 includes game software 110, a game image generation unit 112, a game sound generation unit 114, an output processing unit 116, a state data acquisition unit 120, a situation estimation unit 122, an internal state estimation unit 124, and a comment generation unit 126.

The components described as functional blocks that perform various processes of the information processing apparatus 10 in FIG. 3 can include, in terms of hardware, circuit blocks, memories, and other LSIs and can be implemented, in terms of software, by a program loaded in a memory and so forth. Accordingly, it can be recognized by those skilled in the art that the functional blocks can be implemented in various forms only by hardware, only by software, or by a combination of them and are not restricted to any of them.

The game software 110 at least includes a game program, image data, and sound data. The game program accepts operation information of the inputting device 6 by the user and performs a computation process for moving a game character in a virtual space. The game image generation unit 112 includes a GPU that executes a rendering process and so forth, and generates image data of a game. The game sound generation unit 114 generates sound data of the game. The output processing unit 116 outputs the generated game image and game sound from the outputting device 4.

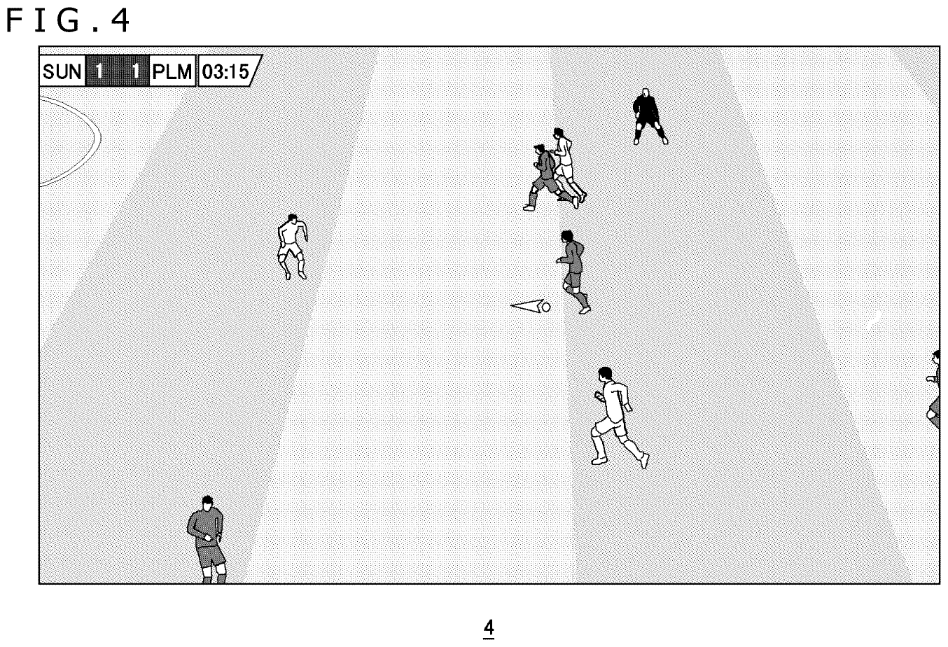

FIG. 4 depicts an example of a game image displayed on the outputting device 4. The user is playing a game titled “ABC soccer.”

The game program outputs state data indicative of a progress state of a game. As hereinafter described, the state data is used to estimate a user's situation in a game. Therefore, the state data preferably includes information necessary for accurately specifying the progress state of the game.

For example, in a soccer game, the state data outputted from the game program includes at least the following information.
Scored points and conceded points
Elapsed time of match
Positions of all players
Position of ball, and moving speed and direction of ball

The game program outputs state data indicative of the progress state of the game at a predetermined cycle, and the state data acquisition unit 120 acquires the state data. While the game program preferably outputs state data at a frame rate of the game image, it may otherwise output the state data in a cycle of once in a plurality of frames.

It is to be noted that the type of information included in the state data differs from game to game. For example, in a baseball game, the state data may include at least the following information.
Scored points and conceded points
Current inning
Out count
Ball count
Base situation

It is to be noted that information such as characteristics of individual players may be included in the state data.

The situation estimation unit 122 estimates a user's game situation from the state data acquired by the state data acquisition unit 120. The situation estimation unit 122 may derive, as the user's game situation, an evaluation value indicative of a degree of whether the progress state of the game is advantageous or is disadvantageous to the user. The evaluation value of the embodiment represents whether the user is in a situation in which the user is likely to score or the user is likely to lose points. The evaluation value ranges from 0 to 100, and the evaluation value of 0 represents a game situation when a point is lost while the evaluation value of 100 represents a game situation when a point is scored. Accordingly, the evaluation value of 50 represents a game situation where the possibility of scoring and the possibility of losing a point are even, and an evaluation value within the range from 50 to 100 represents a situation in which the user is likely to score while an evaluation value within the range from 0 to 50 represents a situation in which the user is likely to lose a point.

The situation estimation unit 122 uses a first trained model that is trained by machine learning and that outputs an evaluation value representative of a user's game situation when state data indicative of a progress state of the game is inputted. The first trained model may be provided from the server apparatus 12. For example, when the user starts the game software 110 of the game titled “ABC soccer,” the system software of the information processing apparatus 10 downloads the first trained model of “ABC soccer” from the server apparatus 12.

The first trained model of “ABC soccer” may be generated by reinforcement learning in which “scoring” is set as a reward. The first trained model is generated by preparing a large amount of game play logs of “ABC soccer” and performing reinforcement learning on values of actions taken by an agent. In the embodiment, by generating the first trained model with high accuracy, it becomes possible to objectively estimate the user's game situation. When state data acquired by the state data acquisition unit 120 is inputted, the first trained model outputs an evaluation value representative of the user's game situation. For example, when the user makes a pass, the evaluation value outputted from the first trained model at this point of time includes various elements such as whether the ball is likely to be passed to a teammate, whether the pass is likely to lead to a score, or whether the degree of chance has increased.

The internal state estimation unit 124 estimates an internal state of the user from the game situation estimated by the situation estimation unit 122. The internal state of the user includes at least an emotion of the user and may further include a degree of excitement. For example, the internal state estimation unit 124 may derive an evaluation value indicative of an emotion and an evaluation value indicative of a degree of excitement.

The internal state estimation unit 124 uses a second trained model that is trained by machine learning and that outputs an evaluation value indicative of an emotion and an evaluation value indicative of a degree of excitement when state data indicative of a progress state of the game and evaluation values representative of a game situation outputted from the situation estimation unit 122 are inputted. The second leaned model may be provided from the server apparatus 12. For example, when the user starts the game software 110 of the game titled “ABC soccer,” the system software of the information processing apparatus 10 downloads the second trained model of “ABC soccer” from the server apparatus 12. That is, in the embodiment, when the user starts the game software 110, the first trained model and the second trained model relating to the game software 110 may be downloaded and recorded into the auxiliary storage device 2.

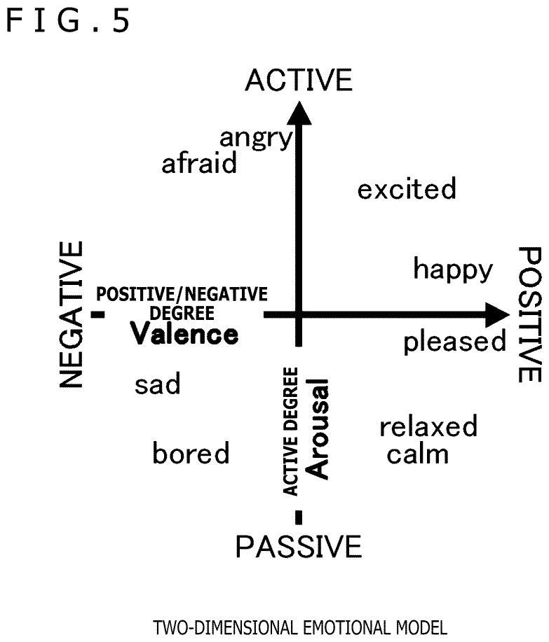

FIG. 5 depicts an example of a two-dimensional emotional model. The example of FIG. 5 indicates a Russel annulus model in which emotions are arranged annularly, with the axis of abscissa indicating an emotional valence (valence) for representing pleasant and unpleasant and the axis of ordinate indicating awakening (arousal). In the Russel annulus model, the first quadrant represents “joy,” the second quadrant represents “anger,” the third quadrant represents “sadness,” and the fourth quadrant represents “enjoyment.” In the embodiment, the Russel annulus model is developed on a two-dimensional plane (XY plane), and the evaluation value indicative of an emotion may be represented by coordinate values (x, y) on the two-dimensional plane on which the Russel annulus mode is developed.

The second trained model of “ABC soccer” may be generated by supervised learning. Teacher data is generated by an annotator performing labeling of an emotion and labeling of a degree of excitement to a scene of an actual game video. In particular, the teacher data may include state data indicative of a progress state of the game in a labeled scene, an evaluation value indicative of a game situation, an emotion label, and a degree-of-excitement label. The second trained model trained using this teacher data outputs, when state data indicative of a progress state of the game and an evaluation value indicative of a game situation are inputted thereto, a label of the emotion and a label of the degree of excitement.

Labeling of an emotion and a degree of excitement for a scoring scene is described. Since a player fluctuates between joy and sorrow for every one play, it is preferable to perform labeling of an emotion depending upon whether the play is good or bad. Therefore, the annotator may basically perform labeling of an emotion on the basis of the situation in the game scene.

Players generally feel happy when they score, but how happy they are depends on how the game unfolds. The significance of a score greatly differs depending upon whether the score is gained when the team is winning 9-0, when the team is tied 0-0, or when the team is losing 0-1. Therefore, as for an emotion of “happy,” it is preferable to represent the degree of happiness, and the labeling of the emotion may be performed stepwise. The annotator preferably performs stepwise emotion labeling while taking the match development into consideration in this manner. The label of an emotion may be associated with coordinate values on the two-dimensional plane on which a two-dimensional emotional model is developed.

The match development significantly affects the degree of excitement. For example, if the team is winning or losing by a wide margin, since the sense of urgency in the game is lost, it is considered that the degree of excitement of a player is low. On the other hand, when the match is progressing in a tie or by a narrow margin, it is considered that the degree of excitement of the player is high. For example, the evaluation value indicative of the degree of excitement ranges from 0 to 10, and the evaluation value of 0 represents an internal state where the user is not excited at all, while the evaluation value of 10 represents an internal state where the user is excited very much. The annotator preferably performs labeling in such a manner that the degree of excitement does not change abruptly but changes slowly.

By using such a second trained model as described above, the internal state estimation unit 124 estimates the internal state of the user from state data indicative of the game situation and the game progress state estimated by the situation estimation unit 122. It is to be noted that the internal state estimation unit 124 of a modification may not use the second trained model but may use, for example, a rule-based model to estimate the internal state of the user from the state data indicative of the game situation and the game progress state estimated by the situation estimation unit 122.

In this case, the internal state estimation unit 124 may determine a coordinate value on the axis of ordinate in the two-dimensional emotional model depicted in FIG. 5 from the game situation estimated by the situation estimation unit 122 and determine a coordinate value on the axis of abscissa from the state data acquired by the state data acquisition unit 120, to thereby estimate an emotion of the user. In any way, the internal state estimation unit 124 estimates the internal state of the user by using the game situation, to thereby make it possible to estimate the emotion and the degree of excitement of the user with high accuracy. The internal state estimation unit 124 supplies the estimated internal state of the user to the comment generation unit 126. At this time, the internal state estimation unit 124 may supply also the game situation estimated by the situation estimation unit 122 to the comment generation unit 126 together with the internal state of the user.

The comment generation unit 126 generates a comment to the user on the basis of at least the estimated internal state of the user. In the two-dimensional emotional model depicted in FIG. 5, the first quadrant represents “joy,” the second quadrant represents “anger,” the third quadrant represents “sadness,” and the fourth quadrant represents “enjoyment.” For example, the comment generation unit 126 may generate a comment on the basis of the quadrant of the two-dimensional emotional model in which the evaluation value representative of the emotion is included. When the user fails to shoot, the comment generation unit 126 generates a comment in the following manner.
In a case where the emotion evaluation value is in the first quadrant

“Good! Let's keep this up!”
In a case where the emotion evaluation value is in the second quadrant

“So close! Let's keep this up!”
In a case where the emotion evaluation value is in the third quadrant

“So close! Let's go hot!”
In a case where the emotion evaluation value is in the fourth quadrant

“Good! Let's go hot!”

Further, the comment generation unit 126 may generate a comment on the basis of the evaluation value indicative of a degree of excitement. For example, if the evaluation value indicative of the degree of excitement is small, the comment generation unit 126 generates a comment “Good!” and if the evaluation value indicative of the degree of excitement is large, the comment generation unit 126 generates a comment “Good! Good! Good!”

It is to be noted that the comment generation unit 126 may generate a comment otherwise on the basis of the evaluation value indicative of an emotion and the evaluation value indicative of a degree of excitement. When the user fails to shoot, the comment generation unit 126 may generate a comment in the following manner on the basis of the evaluation value indicative of an emotion and the evaluation value indicative of a degree of excitement.
In a case where the emotion evaluation value is in the first quadrant and the evaluation value of the degree of excitement is large

“Good! Good! Good! Let's keep this up!”
In a case where the emotion evaluation value is in the second quadrant and the evaluation value of the degree of excitement is small

“So close! Let's keep this up!”
In a case where the emotion evaluation value is in the third quadrant and the evaluation value of the degree of excitement is large

“So close! So close! So close! Let's go hot!”
In a case where the emotion evaluation value is in the fourth quadrant and the evaluation value of the degree of excitement is small

“Good! Let's go hot!”

The comment generation unit 126 supplies the generated comment to the output processing unit 116. At this time, the comment generation unit 126 may supply, together with the generated comment, also the game situation estimated by the situation estimation unit 122 and the internal state of the user estimated by the internal state estimation unit 124 to the output processing unit 116. The output processing unit 116 causes the outputting device 4 to output the received comment in the form of text or voice.

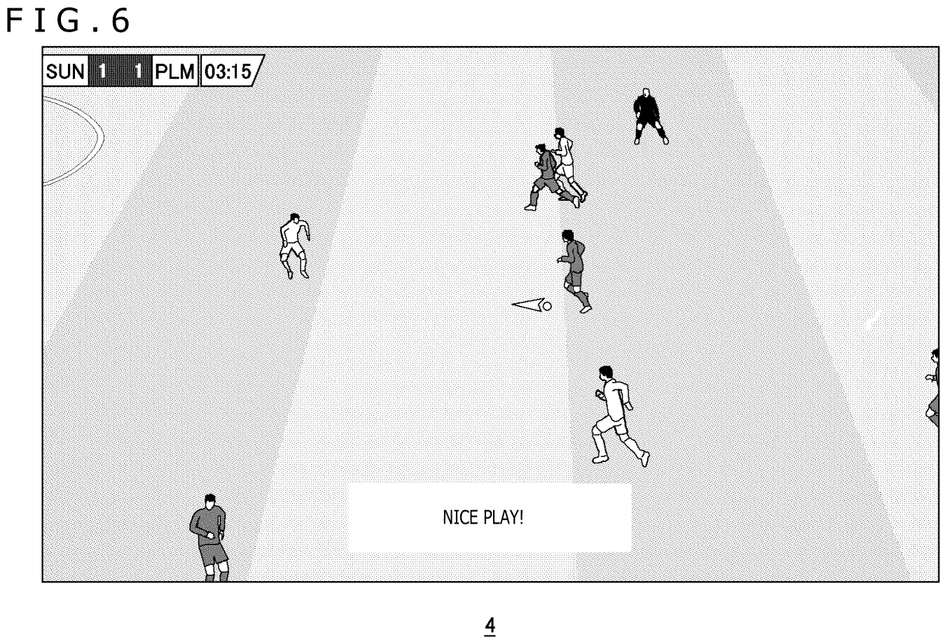

FIG. 6 depicts an example of a comment outputted as text on a game screen. The output processing unit 116 may determine the size, color, and movement of letters according to the internal state of the user and/or the game situation. It is to be noted that the internal state of the user may be displayed in the form of a graph in a partial area of the screen.

It is to be noted that the comment may be outputted by a virtual agent. A plurality of agents having different personalities are prepared, and a selected one of the agents outputs a comment as voice or text to the user. The agent may be selected by the user or may be selected automatically by the comment generation unit 126. For example, if an agent having a positive personality is selected, the comment generation unit 126 may generate a positive comment according to the game situation, and if an agent having a sympathetic personality is selected, the comment generation unit 126 may generate such a comment as to stay close to the user. In the example depicted in FIG. 6, an agent having a sympathetic personality is selected, and a comment “Nice play!” is generated.

The present disclosure has been described in connection with the embodiment. The embodiment is exemplary, and it will be recognized by those skilled in the art that various modifications are possible in combinations of the components and the processing procedures of the embodiment and that also such modifications fall within the scope of the present disclosure.

While, in the embodiment, the internal state estimation unit 124 estimates the internal state of the user only on the basis of the game situation estimated by the situation estimation unit 122, in a modification, the internal state of the user may be estimated using an image of the user captured by the camera 7. Specifically, the internal state estimation unit 124 may extract a facial expression, a gaze direction, a movement of the body, and so forth of the user from the image captured by the camera 7, to estimate an emotion of the user. In a case where the internal state of the user estimated on the basis of the game situation and the internal state of the user estimated on the basis of the captured image are different from each other, the internal state estimation unit 124 may preferentially use the internal state of the user estimated on the basis of the captured image.

### INDUSTRIAL APPLICABILITY

The present disclosure can be used in a technology for generating a comment to a user.

### REFERENCE SIGNS LIST

1 . . . Information processing system
10 . . . Information processing apparatus
12 . . . Server apparatus
100 . . . Processing unit
102 . . . Communication unit
110 . . . Game software
112 . . . Game image generation unit
114 . . . Game sound generation unit
116 . . . Output processing unit
120 . . . State data acquisition unit
122 . . . Situation estimation unit
124 . . . Internal state estimation unit
126 . . . Comment generation unit

1. An information processing apparatus that generates a comment to a user who is playing a game, comprising:
a state data acquisition unit that acquires state data indicative of a progress state of the game;
a situation estimation unit that estimates a user's game situation from the acquired state data;
an internal state estimation unit that estimates an internal state of the user from the estimated game situation; and
a comment generation unit that generates a comment to the user on a basis of the estimated internal state of the user.

2. The information processing apparatus according to claim 1, wherein
the situation estimation unit derives, as the game situation, an evaluation value indicative of a degree with which the progress state of the game is advantageous or disadvantageous to the user.

3. The information processing apparatus according to claim 1, wherein
the internal state estimation unit estimates an emotion of the user as the internal state of the user.

4. The information processing apparatus according to claim 1, wherein
the internal state estimation unit estimates a degree of excitement of the user as the internal state of the user.

5. A comment generation method, comprising:
acquiring state data indicative of a progress state of a game;
estimating a user's game situation from the acquired state data;
estimating an internal state of the user from the estimated game situation; and
generating a comment to the user on a basis of the estimated internal state of the user.

6. A program for causing a computer to implement:
by a state data acquisition unit, acquiring state data indicative of a progress state of a game;
by a situation estimation unit, estimating a user's game situation from the acquired state data;
by an internal state estimation unit, estimating an internal state of the user from the estimated game situation; and
by a comment generation unit, generating a comment to the user on a basis of the estimated internal state of the user.
